(19) United States
(12) Patent Application Publication
(10) Pub. No.: US 2002/0045684 A1
(43) Pub. Date: Apr. 18, 2002

(54) Thickener compositions containing vinyl alcohol copolymers and cellulose ethers

(75) Inventors: Andreas Bacher, Burghausen, DE (US); Werner Bauer, Winhoring (DE); Ulf Dietrich, Altotting (DE); Bernd Kayser, Burghausen (DE); Marion Schmitz, Burghausen (DE); Harald Zeh, Burghausen (DE); Theo Mayer, Julbach (DE); Hardy Herold, Burghausen (DE)

Correspondence Address: WILLIAM G. CONGER, Brooks & Kushman P.C., 22nd Floor, 1000 Town Center, Southfield, MI, 48075-1351, US

(73) Assignee: Wacker-Chemie GmbH, Munchen (DE)

(21) Appl. No.: 09/920,229

(22) Filed: Aug. 1, 2001

(30) Foreign Application Priority Data
Aug. 17, 2000 (DE) 100 40 172.4

(51) Int. Cl. C08K 3/00

(52) U.S. Cl. 524/4; 524/42

(57) ABSTRACT

A thickener based vinyl alcohol copolymers and cellulose ethers, containing

A) one or more fully or partially hydrolyzed vinyl alcohol polymers with a degree of hydrolysis of from 75 to 100 mol % and with a molecular weight Mw greater than 100,000 comprising hydrolyzed and optionally acetalized vinyl acetate copolymers which, besides vinyl acetate units, also contain comonomer units selected from 1-(C₁₋₅)-alkylvinyl esters of C₁₋₅ carboxylic acids, allyl esters, vinyl esters of alpha-branched C₅₋₁₂ carboxylic acids, and C₁₋₁₈-alkyl (meth)acrylates, and

B) one or more cellulose ethers.

### BACKGROUND OF THE INVENTION

1. Field of the Invention

The invention relates to thickeners based on compositions containing vinyl alcohol copolymers and cellulose ethers, and also to the use of these thickeners, in particular in compositions used in the building trades.

2. Background Art

Mixtures of lime hydrate and of cement are used for the masonry, rendering, troweling, bonding and restoration work in the construction industry. Water-soluble polymers are often added to mixtures of lime hydrate and of cement to improve their workability and water-retention properties. The intention is to achieve very good workability while preventing the compositions from losing water prior to setting on highly absorbent substrates. In the absence of such measures, hardening may be inadequate or the construction material may develop cracks. In addition, additives of this type can be used to alter the property profile of the construction material to a more desirable performance profile. The thickening additives which have been used are mainly water-soluble polymers based on cellulose ethers, such as methyl cellulose (MC), hydroxyethyl cellulose (HEC), methyl hydroxyethyl cellulose (MHEC), or methyl hydroxypropyl cellulose (MHPC) (EP-A 773198).

As thickeners, cellulose ethers compete with entirely synthetic polymers, such as associative polyurethane thickeners, polyacrylates, polyamines, and polyamides, and also with naturally occurring water-soluble polymers, such as agar agar, tragacanth, carrageen, gum arabic, alginates, starch, gelatin, and casein. A disadvantage of the cellulose ethers usually used in cement-type construction applications, in particular hydroxyethyl methyl cellulose, is that there is, at times, a considerable delay in cement setting. Although polyvinyl alcohols have been constituents of cement-type compositions, only relatively low-molecular-weight polymers which cannot have a thickening effect have been used. Examples include their use as protective colloids for additives such as polymer dispersions or redispersible polymer powders. Although higher-molecular-weight polyvinyl alcohols may exhibit thickening properties, such polymers exhibit low cold-water solubility and poor workability properties associated with this low solubility.

European published application EP-A 272012 describes the use of vinyl alcohol copolymers as thickeners in aqueous systems such as emulsion paints, where the copolymers comprise, besides vinyl alcohol units, acrylic ester units having at least two ethylene oxide units within the ester radical. Japanese published application JP-A 10/087937 describes the addition of polyvinyl alcohol or vinyl alcohol copolymers with a defined solubility in aqueous Ca(OH)₂ solution to improve the mechanical strength of cement-containing construction materials. The vinyl alcohol copolymers contain carboxyl units, sulfonate units, and N-vinyl units.

European published application EP-A 458328 describes a thickener system for water-containing construction materials which is composed of a combination of cellulose ether, polyvinyl alcohol, and borax. The action of this system is based on the formation of complexes between polyvinyl alcohol and borax. Published application DD-A 251968 describes a process for preparing a dry mortar, where carboxymethyl cellulose and partially hydrolyzed polyvinyl alcohol are added to the dry mortar, the cellulose ether serving as a water-retention agent, and the polyvinyl alcohol serving to improve the properties of the fresh mortar. To improve the adhesion and surface properties of thin render coatings, published application JP-A 59-78963 proposes mixing cement-containing renders with methyl cellulose and with a polyvinyl alcohol which is substituted with both hydrophobic groups and with anionic, hydrophilic groups. The hydrophobic groups are introduced by copolymerization with hydrophobic comonomers, and the hydrophilic groups are introduced by copolymerization with vinylsulphonic acid or by sulfonation.

### SUMMARY OF THE INVENTION

It was an object of the invention to provide an entirely synthetic water-soluble polymer which acts as a thickener in formulations used in civil engineering, and in particular in cement-type formulations, and which produces excellent workability properties and mechanical properties, but does not have the abovementioned disadvantages. The inventive thickeners contain both specific polyvinyl alcohol polymers or copolymers and certain cellulose ethers.

### DETAILED DESCRIPTION OF THE PREFERRED EMBODIMENT(S)

The invention provides thickeners comprising vinyl alcohol copolymers and cellulose ethers, where

A) one or more fully or partially hydrolyzed vinyl alcohol polymers with a degree of hydrolysis of from 75 to 100 mol % and with a molecular weight Mw greater than 100,000 is/are present, these polymers being

a) hydrolyzed vinyl acetate copolymers which, besides vinyl acetate units, also contain comonomer units of one or more comonomers selected from 1-(C₁₋₅)-alkylvinyl esters of C₁₋₅-carboxylic acids; allyl esters, vinyl esters of alpha-branched C₅₋₁₂ carboxylic acids; and C₁₋₁₈-alkyl (meth)acrylates, or

b) acetalized hydrolyzed vinyl acetate copolymers (a) or hydrolyzed vinyl acetate homopolymers with aliphatic or aromatic, unsubstituted or substituted, aldehydes, and

B) one or more cellulose ethers selected from alkyl cellulose ethers, hydroxyalkyl cellulose ethers, carboxyalkyl cellulose ethers, and hydroxyalkylpolyoxyalkyl cellulose ethers, in each case having C₁₋₁₀ alkyl radicals, and mixed ethers of cellulose having at least two different substituents selected from alkyl radicals, hydroxyalkyl radicals, carboxyalkyl radicals, and hydroxyalkylpolyoxyalkyl radicals, in each case having C₁₋₁₀-alkyl radicals.

The preferred 1-(C₁₋₅)-alkylvinyl ester is isopropenyl acetate. Preferred vinyl esters of alpha-branched carboxylic acids are those of alpha-branched carboxylic acids having from 9 to 11 carbon atoms, and particular preference is given to vinyl esters of alpha-branched carboxylic acids having 10 carbon atoms (VeoVa10, trade name of Shell). Preferred acrylic and methacrylic esters are those of C₁₋₁₀ alcohols. Particular preference is given to methyl acrylate, ethyl acrylate, butyl acrylate, 2-ethylhexyl acrylate, methyl methacrylate, and 2-ethylhexyl methacrylate.

The degree of hydrolysis of the partially or fully hydrolyzed vinyl alcohol copolymers is from 75 to 100 mol %, and in the case of “fully hydrolyzed” vinyl alcohol polymers it is preferably from 97.5 to 100 mol %, more preferably from 98 to 99.5 mol %, and in the case of partially hydrolyzed vinyl alcohol polymers it is preferably from 80 to 95 mol %, more preferably from 86 to 90 mol %. The proportion of the comonomer units in the polyvinyl alcohol copolymers is from 0.1 to 50% by weight, preferably from 0.3 to 15% by weight, and more preferably from 0.5 to 6% by weight, based in each case on the total weight of the vinyl alcohol copolymer.

Particular preference is given to vinyl alcohol copolymers obtained by hydrolyzing vinyl acetate copolymers having from 0.3 to 15% by weight of isopropenyl acetate comonomer; vinyl esters of alpha-branched carboxylic acids having from 9 to 11 carbon atoms; methyl, ethyl, butyl or 2-ethylhexyl acrylate; methyl methacrylate; or 2-ethylhexyl methacrylate. Particular preference is also given to those copolymers having from 0.3 to 15% by weight of isopropenyl acetate units and from 0.3 to 15% by weight of units derived from vinyl esters of alpha-branched carboxylic acids having from 9 to 11 carbon atoms. Finally, particular preference is also given to vinyl alcohol copolymers having from 0.5 to 6% by weight of units derived from isopropenyl acetate, from 0.5 to 6% by weight of vinyl esters of alpha-branched carboxylic acids having 10 carbon atoms (i.e., VeoVa10), and from 0.5 to 6% by weight of methyl acrylate; and to vinyl alcohol copolymers having from 0.5 to 6% by weight of isopropenyl acetate, from 0.5 to 6% by weight of 2-ethylhexyl methacrylate, and from 0.5 to 6% by weight of methyl acrylate derived moieties.

When use is made of acetalized vinyl alcohol homo- or copolymers, the partially or fully hydrolyzed vinyl acetate homo- or copolymers used comprise polymers acetalized by aliphatic or aromatic aldehydes, preferably aldehydes having from 1 to 10 carbon atoms, being unsubstituted or substituted with one or more substituents selected from hydroxyl, carboxyl, sulfonate, ammonium and aldehyde radicals. Preference is given to formaldehyde, acetaldehyde, benzaldehyde, glyoxylic acid, and glyceraldehyde. Where appropriate, masked aldehydes may be used, for example in the form of their hemiacetals or acetals, or in the form of aldehydes having a protective group. The degree of acetalization, i.e. the degree of protection of the free hydroxyl groups in the hydrolyzed vinyl acetate polymers, is from 0.5 to 100 mol %, preferably from 0.5 to 70 mol %, in particular from 0.5 to 20 mol %.

The vinyl alcohol copolymers may be prepared by known processes such as bulk, solution, suspension or emulsion polymerization. Solution polymerization preferably takes place in alcoholic solution, for example in methanol, ethanol or isopropanol. Suspension polymerization and emulsion polymerization are carried out in an aqueous medium. The polymerization is preferably carried out at a temperature of from 5° C. to 90° C. with free-radical initiation using initiators conventionally used for the respective polymerization process. The vinyl alcohol units are introduced into the copolymer by copolymerization of vinyl acetate, the acetate radicals being hydrolyzed in a subsequent hydrolysis step in the same manner as the other hydrolyzable monomer units. The molecular weight may be adjusted conventionally by adding regulators (i.e. chain transfer agents), by varying the solvent content, by varying the initiator concentration, by varying the temperatures or by combinations of these methods. After completion of the polymerization, solvent is distilled off, where appropriate, or the polymer is isolated from the aqueous phase by filtration.

Hydrolysis takes place conventionally under alkaline or acidic conditions, by the appropriate addition of base or acid. The vinyl acetate copolymer to be hydrolyzed is preferably dissolved in alcohol, for example methanol, at a solids content of from 5 to 50%. The hydrolysis is preferably carried out under basic conditions, for example by adding NaOH, KOH, or NaHCO₃. The resultant vinyl alcohol copolymer may be isolated from the reaction mixture by filtration or by distillation of the solvent mixture. The filtered product is then dried and ground by conventional methods.

It is also possible to obtain an aqueous solution of the polymer by adding water, advantageously in the form of superheated steam, during the distillation of the organic solvents. For the work-up of an aqueous solution, preference is given to spray drying and to precipitation of the vinyl alcohol copolymer, for example using methanol. Work-up continues with a drying step and a grinding step. Grinding generally proceeds until the resultant average particle size is less than 1 mm, preferably less than 200 μm.

For acetalization, the partially or fully hydrolyzed vinyl acetate homo- or copolymers are preferably added to an aqueous medium. Acetalization takes place in the presence of acidic catalysts such as hydrochloric acid, sulfuric acid, or phosphoric acid. After addition of the catalyst, the acetalization reaction is initiated at a temperature of from 0° C. to 80° C., preferably from 10° C. to 40° C., by adding the aldehyde, and is carried out over a period of from 1 to 10 hours, preferably from 1 to 4 hours. Since the acetalization proceeds to almost full conversion, the amount of aldehyde to be added can be determined by simple stoichiometric calculation. The mixture is then neutralized by adding base, and the product is precipitated by dropwise addition to a solvent. Work-up continues with a drying step and a grinding step. Grinding generally proceeds until the resultant average particle size is less than 1 mm, preferably less than 200 μm.

Examples of suitable alkyl cellulose ethers are methyl cellulose ethers and ethyl cellulose ethers; examples of suitable hydroxyalkyl cellulose ethers are hydroxyethyl cellulose ethers and hydroxypropyl cellulose ethers; examples of carboxyalkyl cellulose ethers are carboxymethyl cellulose ethers; and examples of mixed ethers of cellulose are hydroxyethyl methyl cellulose ethers, hydroxypropyl methyl cellulose ethers, and hydroxyethyl ethyl cellulose ethers. These examples are not limiting. Preference is given to cellulose ethers with an average degree of substitution “DS” of from 0.1 to 3.0, more preferably from 0.5 to 1.5. Preference is also given to cellulose ethers with a Höppler viscosity of from 5 000 to 70 000 mPa·s, in particular from 20,000 to 50,000 mPa·s (Höppler method, DIN 53015, 2 weight % aqueous solution).

The ratios for mixing polyvinyl alcohol component A) and cellulose ether component B) are such that from 1 to 50% by weight, preferably from 1 to 20% by weight, of cellulose ether is present, based on the total weight of A) and B). The thickener compositions may be prepared by blending polyvinyl alcohol component A) and cellulose ether component B) in a separate mixing procedure. When preparing thickener compositions based on hydrolyzed vinyl acetate copolymers, it is preferable to add the cellulose ether prior to the hydrolysis process and to carry out the hydrolysis of the vinyl acetate copolymers in the presence of cellulose ether component B). When preparing thickener compositions based on acetalized hydrolyzed vinyl acetate polymers, it is preferable for the cellulose ether to be supplied either in the aqueous solution of the acetal or in the precipitation solvent. In the latter two instances, work-up continues with a drying step and a grinding step. Grinding generally proceeds until the resultant average particle size is less than 1 mm, preferably less than 200 μm.

The thickener composition may be used in the form of an aqueous solution or in powder form, or as an additive in aqueous polymer dispersions, or in water-redispersible polymer powders. It may be used alone or in admixture with other rheology additives. The amount of the thickener composition generally used is from 0.01 to 20% by weight of thickener composition (solid), based on the total weight of the composition to be thickened. The thickener composition is suitable for use as a thickener in any technology where rheological auxiliaries are used, for example as a thickener in cosmetics; in pharmaceuticals; in water-based silicone emulsions; in silicone oils, in coating compositions such as emulsion paints or textile coatings; as a thickener in adhesive compositions; and as a thickener in construction applications, either in hydraulically setting compositions or in non-hydraulically setting compositions, for example concrete, cement mortar, lime mortar, or gypsum mortar. There are other possible applications in water-containing mixes which also use cellulose ethers and starch ethers as thickeners. Particular preference is given to applications in the construction industry. Very particular preference is given to cement-type construction applications, such as cement-type construction adhesives (tile adhesives), cement-type dry mortars, cement-type flowable compositions, cement-type renders, grouts, and cement-type exterior insulation system adhesives, and cement-type non-shrink grouts.

Typical mixes for cement-type construction adhesives comprise from 5 to 80% by weight of cement, from 5 to 80% by weight of fillers such as quartz sand, calcium carbonate or talc, from 0.5 to 60% by weight of polymer dispersion or redispersible polymer powder, from 0.1 to 5% by weight of thickeners, and, where appropriate, other additives for improving stability, workability, open time, and water resistance. The data given here in % by weight are always based on 100% by weight of dry material of the mix and give a total of 100% by weight. The cement-containing construction adhesive mixes mentioned are used especially as tile adhesives for tiles of any type (earthenware, stoneware, porcelain, ceramics, natural tiles), indoors or outdoors, and are mixed with the appropriate amount of water prior to use.

The thickener compositions of the invention are also suitable for use in cement-free construction mixes, for example with the appropriate amount of gypsum or water glass as inorganic binder, and preferably in gypsum-containing compositions, such as gypsum renders or gypsum troweling compositions. The cement-free mixes are used especially in troweling compositions, tile adhesives, exterior insulation system adhesives, renders, or paints. Typical mixes for gypsum formulations comprise from 15 to 96% by weight of calcium sulfate, from 3 to 80% by weight of fillers, such as quartz sand, calcium carbonate or talc, from 0 to 5% by weight of hydrated lime, from 0 to 5% by weight of polymer dispersion or polymer powder, and also from 0.01 to 3% by weight of thickeners, and, where appropriate, other additives for improving stability, workability, open time and water resistance. The data in % by weight are always based on 100% by weight of dry material of the mix, and give a total of 100% by weight.

The examples below give further illustration of the invention.

### EXAMPLE 1

612 g of water, 61.2 mg of copper (II) acetate, and 61.2 g of a 5% strength polyvinylpyrrolidone solution (PVP-K90) form an initial charge in water under nitrogen in a laboratory apparatus of 2.5 liter capacity, fitted with a thermostat. A solution of 620 mg of tert-butyl 2-ethylperhexanoate (TBPEH), 322 mg of tert-butyl perneodecanoate (TBPND), and 6.12 g of VeoVa10 in 612 g of vinyl acetate was added, with stirring. The reactor was heated to 51.5° C. and, once the reaction had subsided, heated stepwise to 75° C. The mixture was held for a further 2 hours at this temperature and then cooled. The resultant polymer beads were suction-filtered, washed well with water, and dried. Polymer beads (90 g) were dissolved in 810 g of methanol at 50° C. in a laboratory reactor of 2.5 liter capacity. The solution was cooled to 30° C., and 2.25 g of hydroxyethyl methyl cellulose with a Höppler viscosity of 40,000 mPa·s (2 weight % aqueous solution) were added, and, with the stirrer stationary, this mixture was covered with 500 g of methanol and immediately mixed with methanolic NaOH (10 g of NaOH (46% strength in water) dissolved in 90 g of methanol), and the stirrer was energized. The solution became increasingly cloudy. During the gel phase, the stirrer set to a higher rotation rate in order to comminute the gel. After the gel phase, the reaction was continued for a further 2 hours followed by neutralization with acetic acid, and the resultant solid was filtered off, washed, dried, and ground.

### EXAMPLE 2

The procedure of example 1 was followed, but the amount of hydroxyethyl methyl cellulose added was twice as great, namely 4.5 g.

### EXAMPLE 3

The procedure of example 2 was followed, but instead employing 4.5 g of hydroxyethyl methyl cellulose with a Höppler viscosity of 15,000 mPa·s (2% by weight aqueous solution).

### EXAMPLE 4

The procedure of example 2 was followed, but instead employing 4.5 g of hydroxyethyl methyl cellulose with a Höppler viscosity of 60,000 mPa·s (2% by weight aqueous solution).

### EXAMPLE 5

The procedure of example 2 was followed, but 6.12 g of methyl acrylate were also copolymerized.

### EXAMPLE 6

The procedure of example 2 was followed. However, the resultant polyvinyl alcohol, in the form of a 6.6% strength aqueous solution (1,000 g) formed an initial charge in a laboratory apparatus of 2.5 liter capacity, equipped with a thermostat. The reactor was maintained at 30° C. and a pH of 3.5 by addition of a 10% strength hydrochloric acid. 3.30 g of acetaldehyde were metered in over a period of 1 hour. The mixture was held at this temperature for a further 2 hours, and then cooled. A 10 weight % sodium hydroxide solution was then used to neutralize the mixture. The solution was poured dropwise into a large excess of methanol in which had been suspended 6.6 g of hydroxyethyl methyl cellulose with a Höppler viscosity of 40,000 mPa·s (2 weight % aqueous solution). The precipitated mixture was isolated, dried, and ground.

### COMPARATIVE EXAMPLE 7

Commercially available hydroxyethyl methyl cellulose with a Höppler viscosity of 6,000 mPa·s (2 weight % aqueous solution).

### COMPARATIVE EXAMPLE 8

Commercially available hydroxyethyl methyl cellulose with a Höppler viscosity of 40,000 mPa·s (2 weight % aqueous solution).

Testing of thickeners from examples 1 to 6 and comparative examples 7 and 8:

The thickeners were tested in the following formulation:

55.2 parts by weight of quartz sand No. 9a (0.1-0.4 mm),

43.0 parts by weight of cement 42.5 (Rohrdorfer),

1.5 parts by weight of redispersible polymer powder (Vinnapas® RE 530 Z),

0.7 part by weight of thickener.

The dry mixture was mixed with the amount of water given in table 1 and the mixture was allowed to stand for 5 minutes, and then tested. The test results are given in table 1. The test methods are presented below.

Determination of Plasticity:

The plasticity of the mixture was determined qualitatively by stirring the formulation. Results were evaluated on a grading scale from 1 to 6, grade 1 being the best.

Determination of Wetting Properties:

To determine wetting properties, the formulation was applied to a fiber-reinforced concrete panel using a serrated trowel, and the wetting of the panel was assessed qualitatively. Results were evaluated on a grading scale from 1 to 6, grade 1 being the best.

Determination of Quality of Bead Production:

The formulation was applied to a fiber-reinforced concrete panel using a serrated trowel, and the quality of the resultant beads was assessed qualitatively. Results were evaluated on a grading scale from 1 to 6, grade 1 being the best.

Determination of Water Retention:

Water retention was determined in accordance with DIN 18555 Part 7. Table 1 gives the proportion of water which remained in the formulation.

Determination of Break-out:

The tile adhesive formulation was applied to a fiber-reinforced concrete panel, and after 10 minutes a tile (5 cm×5 cm) was laid. The tile was then loaded with a weight of 2 kg for 30 seconds. After a further 60 minutes, the tile was removed and the percentage of the reverse side of the tile still covered with adhesive was determined.

Determination of Stability (Slip Test):

For the slip test, a tile (15 cm×15 cm) was placed as above into the tile adhesive formulation and was loaded with a 5 kg weight for 30 seconds, and the sample structure was placed vertically. The upper edge of the tile was then loaded with weights, in each case for 30 seconds, and the weight at which the tile slips was determined.

Determination of Cement-setting Performance:

Cement-setting performance was determined using a heat sensor in the tile adhesive formulation. The time taken for setting to begin was determined, and the retardation (values greater than 100) or the acceleration (values less than 100) of setting was determined relative to that of a formulation with no thickener.

Discussion of Test Results:

The test results show that the thickener compositions of the invention (examples 1 to 6) give markedly better workability (plasticity, wetting, bead quality) than conventional cellulose ethers (comparative examples 7 and 8), while the thickening effect is comparable (break-out, water retention, slip). Compared with conventional thickeners based on cellulose ethers (comparative examples 7 and 8), the thickener compositions give markedly accelerated setting performance (cement setting).

TABLE 1

| | | | | | | Water | | |
|---|---|---|---|---|---|---|---|---|
| | | | | Bead | Break- | Reten- | | Cement |
| Exam- | | Plas- | Wet- | qual- | out | tion | Slip | setting |
| ple | (g) | ticity | ting | ity | (%) | (%) | (g) | (%) |
| Ex. 1 | 22.3 | 1 | 1 | 1 | 98 | 98.0 | 400 | 105 |
| Ex. 2 | 23.1 | 1 | 1 | 1 | 96 | 98.1 | 200 | 110 |
| Ex. 3 | 22.9 | 1 | 1 | 1 | 92 | 98.1 | 200 | 107 |
| Ex. 4 | 23.5 | 1 | 1 | 1.5 | 97 | 98.4 | 400 | 115 |
| Ex. 5 | 24.1 | 1 | 1 | 1.5 | 96 | 98.3 | 400 | 106 |
| Ex. 6 | 23.0 | 1 | 1 | 1 | 98 | 98.5 | 200 | 105 |
| Comp. | 23.5 | 2.5 | 2.5 | 1.5 | 97 | 98.3 | 200 | 170 |
| Ex. 7 | | | | | | | | |
| Comp. | 26.0 | 3.0 | 2.0 | 1.5 | 95 | 98.3 | 400 | 185 |
| Ex. 8 | | | | | | | | |

The testing of the thickeners in gypsum-containing mixes (gypsum renders) was carried out with the following formulation:

| | | |
|---|---|---|
| Calcium sulfate (Primoplast - Hilliges Gipswerk) | 700 | g |
| Quartz sand (No. 7; 0.2-0.7 mm) | 237.6 | g |
| Perlite light-weight filler (3 mm) | 25 | g |
| Hydrated lime (Walhalla) | 35 | g |
| Retarder (Retardan, aminobutyraldehyde condensate) | 0.4 | g |
| Thickener | 2 | g |

Test Methods:

The test results are given in Table 2.

Determination of Air Pore Content:

Air pore content was determined to DIN 18555 Part 2.

Determination of Water Retention:

Water retention was determined to DIN 18555 Part 7.

Plasticity:

The plasticity of the mixture was determined qualitatively by stirring the formulation. The results were evaluated on a grading scale from 1 to 6, grade 1 being the best.

Determination of Stability:

The stability of the formulation was determined qualitatively by passing a trowel through the mixture. The results were evaluated on a grading scale from 1 to 6, grade 1 being the best.

Post-thickening:

The post-thickening of the formulation was assessed qualitatively after a waiting time of 5 minutes. The results were evaluated on a grading scale from 1 to 6, grade 1 being the best.

Start of Setting (SS), Completion of Setting (CS):

The time taken for setting to begin was determined by means of a needle repeatedly inserted into the formulation. The start of setting is the juncture at which the insertion depth of the needle begins to be smaller, with the same force exerted. Once setting had been completed, it was no longer possible to insert the needle by exerting the same force.

Felting Time:

The formulation was troweled onto a brick wall and smoothed with a timber batten after a waiting time. The render was then felted using a moistened sponge. The felting time is the time from which felting can be begun without breaking up the render (measured from application of the formulation).

Slump:

The formulation is placed in a settling funnel on a slump table to DIN 1060 Part 3, and the slump of the mixture is measured 1 minute after removing the funnel, and also after using 15 impacts to vibrate the specimen.

Shrinkage:

Test specimens are prepared from the mixture, and the change in length of the longitudinal axis of the prisms is determined after 28 days using a test device to DIN 52450.

TABLE 2

| | H₂O | H₂O retention | Air pores | Slump | Slump after |
|---|---|---|---|---|---|
| Thickener | (g) | (%) | (%) | (cm) | vibration (cm) |
| Ex. 2 | 435 | 98.4 | 11.9 | 10.1 | 15.8 |
| C. ex. 7 | 420 | 98.9 | 8.8 | 10.0 | 15.5 |

| | | | | | | Shrink- | Felting |
|---|---|---|---|---|---|---|---|
| | SS | CS | Post- | Plas- | | age | time |
| Thickener | (min) | (min) | thickening | ticity | Stability | (mm/m) | (min) |
| Ex. 2 | 95 | 115 | 1 | 1.0 | 1.0 | 0.247 | 48 |
| C. ex. 7 | 100 | 120 | 1 | 2.0 | 3.0 | 0.261 | 55 |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. By terms such as “vinyl acetate units,” “2-ethylhexl acrylate units” and the like is meant moieties in the polymer or copolymer derived from these monomers.

What is claimed is:

1. A thickener comprising a mixture of
A) one or more fully or partially hydrolyzed vinyl alcohol polymers with a degree of hydrolysis of from 75 to 100 mol % and with a molecular weight Mw greater than 100,000 comprising
a) a hydrolyzed vinyl acetate copolymer which, in addition to vinyl acetate monomer units, also contains comonomer units selected from 1-(C₁₋₅)-alkylvinyl esters of C₁₋₅-carboxylic acids, allyl esters; vinyl esters of alpha-branched C₅₋₁₂ carboxylic acids having from 5 to 12 carbon atoms, and C₁₋₁₈-alkyl (meth)acrylates, or
b) acetalized polymers selected from acetalized
b)i hydrolyzed vinyl acetate copolymers a), or
b)ii hydrolyzed vinyl acetate homopolymers, said hydrolyzed vinyl acetate copolymers b)i and hydrolyzed vinyl acetate homopolymers b)ii acetalized with optionally substituted aliphatic or aromatic aldehydes, and
B) one or more cellulose ethers selected from alkyl cellulose ethers, hydroxyalkyl cellulose ethers, carboxyalkyl cellulose ethers, and hydroxyalkylpolyoxyalkyl cellulose ethers, and mixed ethers of cellulose having at least two different substituents selected from the group consisting of alkyl radicals, hydroxyalkyl radicals, carboxyalkyl radicals, and hydroxyalkylpolyoxyalkyl, the alkyl groups of said cellulose ethers and mixed ethers being C₁₋₁₀-alkyl radicals.

2. The thickener of claim 1, wherein said vinyl acetate polymer a) contains comonomer units derived from one or more comonomers selected from isopropenyl acetate, vinyl esters of alpha-branched C₉₋₁₁ carboxylic acids, and C₁₋₁₀-alkyl (meth)acrylates.

3. The thickener of claim 1, wherein the proportion of each non-vinyl acetate comonomer is from 0.3 to 15% by weight, based on the total weight of the vinyl alcohol copolymer.

4. The thickener of claim 2, wherein the proportion of each non-vinyl acetate comonomer is from 0.3 to 15% by weight, based on the total weight of the vinyl alcohol copolymer.

5. The thickener of claim 1, wherein at least one vinyl alcohol copolymer comprises
a)i) a copolymer having from 0.3 to 15% by weight of any of isopropenyl acetate, vinyl ester(s) of alpha-branched C₉₋₁₁carboxylic acids, methyl, ethyl, butyl or 2-ethylhexyl acrylate, or 2-ethylhexyl methacrylate;
a)ii) vinyl alcohol copolymers having from 0.3 to 15% by weight of isopropenyl acetate units and from 0.3 to 15% by weight of vinyl esters of alpha-branched C₉₋₁₁ carboxylic acids;
a)iii) vinyl alcohol copolymers having from 0.5 to 6% by weight of isopropenyl acetate, from 0.5 to 6% by weight of vinyl esters of alpha-branched C₁₀ carboxylic acids, and from 0.5 to 6% by weight of methyl acrylate; or
a)iv) vinyl alcohol copolymers having from 0.5 to 6% by weight of isopropenyl acetate, from 0.5 to 6% by weight of 2-ethylhexyl methacrylate, and from 0.5 to 6% by weight of methyl acrylate.

6. The thickener of claim 2 wherein said vinyl alcohol copolymer comprises
a)i) a copolymer having from 0.3 to 15% by weight of isopropenyl acetate, vinyl ester(s) of alpha-branched C₉₋₁₁ carboxylic acids, methyl, ethyl, butyl or 2-ethylhexyl acrylate, or 2-ethylhexyl methacrylate;
a)ii) vinyl alcohol copolymers having from 0.3 to 15% by weight of isopropenyl acetate and from 0.3 to 15% by weight of vinyl esters of alpha-branched C₉₋₁₁ carboxylic acids;
a)iii) vinyl alcohol copolymers having from 0.5 to 6% by weight of isopropenyl acetate, from 0.5 to 6% by weight of vinyl esters of alpha-branched C₁₀ carboxylic acids, and from 0.5 to 6% by weight of methyl acrylate; or
a)iv) vinyl alcohol copolymers having from 0.5 to 6% y weight of isopropenyl acetate, from 0.5 to 6% by weight of 2-ethylhexyl methacrylate, and from 0.5 to 6% by weight of methyl acrylate.

7. The thickener of claim 1, wherein the partially or fully hydrolyzed vinyl acetate homo- or copolymers present comprise polymers which have been acetalized using aliphatic or aromatic aldehydes.

8. The thickener of claim 7, wherein the aliphatic or aromatic aldehydes are substituted by one or more substituents selected from hydroxyl, carboxyl, ammonium, aldehyde and sulfonate radicals.

9. The thickener of claim 7, wherein the degree of acetalization is from 0.5 to 100 mol %.

10. The thickener of claim 8, wherein the degree of acetalization is from 0.5 to 100 mol %.

11. The thickener of claim 1, wherein the cellulose ethers present comprise ethers with an average degree of substitution of from 0.1 to 3.0.

12. The thickener of claim 1, wherein the cellulose ether(s) comprise one or more ether(s) selected from methyl cellulose ethers, ethyl cellulose ethers, hydroxyethyl cellulose ethers, hydroxypropyl cellulose ethers, carboxymethyl cellulose ethers, hydroxyethyl methyl cellulose ethers, hydroxypropyl methyl cellulose ethers, and hydroxyethyl ethyl cellulose ethers.

13. The thickener of claim 1, wherein the weight ratio of polyvinyl alcohol component A) and cellulose ether component B) is such that from 1 to 50% by weight of cellulose ether is present, based on the total weight of A) and B).

14. A process for preparing the thickener of claim 1, comprising blending polyvinyl alcohol A) and cellulose ether B), polyvinyl alcohol A) and cellulose ether B) having been separately prepared.

15. A process for preparing the thickener of claim 1, comprising adding at least a portion of the cellulose ether B) prior to hydrolyzing an unhydrolyzed or only partially hydrolyzed vinyl acetate copolymer, and hydrolyzing or further hydrolyzing the vinyl acetate copolymer(s) in the presence of cellulose ether component B).

16. A process for preparing the thickeners of claim 1, comprising supplying the cellulose ether in aqueous solution with hydrolyzed and acetalized vinyl acetate polymer or in the precipitation solvent, and precipitating acetalized polymer b) in the presence of cellulose ether component B).

17. In a process for thickening a cosmetic composition, a pharmaceutical composition, a water-based silicone emulsion, a silicone oil, a coating composition, an adhesive composition, or a construction composition, wherein a thickness is added to said composition, the improvement comprising supplying to said composition from 0.01 to 20% by weight of the thickener composition of claim 1, based on the total weight of the composition to be thickened, said thickener in the form of an aqueous dispersion or a water-redisposible powder.

18. A thickened hydraulically setting or non-hydraulically setting construction composition, comprising the thickener composition of claim 1.

19. A thickened cement-based construction adhesive, dry mortar, flowable composition, render, exterior insulation system adhesive, or cement-based non-shrink grout comprising the thickener of claim 1.

20. A thickened cement-free troweling composition, render, tile adhesive, or exterior insulation system adhesive, comprising the thickener of claim 1.

21. The construction composition of claim 18 which is a gypsum-containing composition.

22. The construction composition of claim 21 which is a render or a troweling composition.

23. The construction composition of claim 18, further comprising a water-redispersible redispersion powder.
